(19) United States
(12) Patent Application Publication
(10) Pub. No.: US 2012/0201559 A1
(43) Pub. Date: Aug. 9, 2012

(54) CALIBRATED REFLECTION DENSITOMETER

(76) Inventor: William D. Holland, Palo Alto, CA (US)

(21) Appl. No.: 13/259,577

(22) PCT Filed: Oct. 30, 2009
(86) PCT No.: PCT/US09/62882

§ 371 Date: Sep. 23, 2011

(51) Int. Cl. G03G 15/00

(52) U.S. Cl. 399/74

(57) ABSTRACT

A printer apparatus 100 includes a reflection densitometer 102 comprising an optical sensor 104 that detects light reflected from each color patch on each page in a sequence of measurements, and a processor 106 which is coupled to the optical sensor 104 and manages the calibration and measurement operations. The processor 106 determines the magnitude of a gloss component of the illumination and compares the gloss component magnitude from a plurality of measurements at selected dissimilar ink coverage.

### BACKGROUND

Commercial digital printing presses can produce printed output with quality which rivals that of traditional lithographic printing presses. Although printing process variations are unavoidable, high output quality and consistent color reproduction can be attained through measurement of the ink densities on the printed page and feedback control of the printing process. Ideally, every press has one or more reflection densitometers scanning printed pages to provide feedback. Unfortunately, the cost of densitometers is substantial, for example with commercial units costing $500 to $2000 or more.

Inexpensive reflection densitometers can be constructed, generally with a less accurate measurement of ink density and thus reduced output quality and reduced color reproduction fidelity. One possibility for cost reduction is simplification of the optical system from that required by the governing International Standards Organization (ISO) standards. Governing standards document specifying the required optical geometry for reflection density measurement is ISO standard 5-4:1995, Photography—Density Measurements—Part 4: Geometric conditions for reflection density. The standards specify a complex optical geometry to achieve a level of instrument and manufacturer interchangeability including illumination from an annular region at 45±5° and detection of the reflected light in a cone at 0±5°. Angles are measured with respect to the page normal. FIG. 9 is a graphical diagram showing the standard optical geometry. The diagram shows an annular cone of light at 45±5° for illuminating a specimen. The diagram also shows a cone of light at 0±5° that is collected from the specimen. The geometry depicts the annular influx mode.

In photography, what is known as “flat” lighting is used to de-emphasize surface texture and gloss. The quality of flat lighting results because the light is diffuse and arrives at the subject uniformly from all directions. The ISO standard calls for annular illumination according to the annular influx mode and thus illuminates from all azimuthal directions, but only 45°±5° in elevation angle, creating approximately flat lighting. Illumination at 45° combined with detection at 0° also de-emphasizes gloss, or specular reflections. Specular reflections occur at the top surface of the ink or paper, tend to be horizontally polarized, and tend to have the spectrum of the light source. Diffuse reflections arise inside the ink and paper, tend to be randomly polarized, and have the spectrum of the printed matter. What is desired is to detect only the diffusely reflected light. The standard optical geometry selectively collects diffusely reflected light as opposed to specularly reflected light. The paper and colorants (inks) determine the intensity and color or spectrum of the diffusely reflected light, but the specular reflection originates at the boundary of air with paper or ink. The spectrum of the specular reflection tends to be that of the illuminant, and tends to be directional. The specular reflection also tends to be uniform across the entire page in both printed and unprinted (paper) areas. In fact, pages of the highest print quality have uniform gloss (specular reflection).

The ISO standard optical geometry for reflection density measurements has the depicted form, possibly to attain interchangeability with densitometers from different manufacturers. Unfortunately the geometry is expensive and fabrication of a sensor that conforms fully to the ISO standard is difficult.

FIGS. 10A and 10B are two-dimensional cross-sectional block and pictorial diagrams that show examples of a prior-art sensor 1000 that conforms to the ISO standard optical geometry. Light emerges from a light source 1002, for example a 50 watt tungsten lamp, and is collected and bent 90° by a ring-shaped mirror 1004 which in cross-section appears as two concave optical elements 1006A and 1006B, and illuminates a printed sheet 1008. The ring-shaped mirror 1004 can produce ideal annular illumination. In the illustrative sensor, two mirrored concave optical surfaces 1006A are optical elements for lighting that can be used to implement the ring-shaped mirror 1004. The sensor 1000 includes a diffraction grating 1010 and a sensor array 1012 to form a true spectrometer 1014 which measures light intensity across the visible spectrum. The sensor 1000 is circularly symmetric around a vertical axis for the optical illumination path, along with a simple one-dimensional optical measurement path, for example including the deflection mirror 1004, along an optical light guide 1016, and to a diffraction grating 1018. The optical path 1016 has good correspondence to the ideal ISO standard optical path.

One inexpensive implementation of a reflection densitometer illuminates from a single direction at 30±5° and detects the reflected light at 0±5°. The problem is illumination from a single direction at an angle shallower than 45° highlights unwanted specular or gloss reflections, for example as occurs when holding a printed page at an oblique angle with respect to a desk lamp to see the gloss. A problem is that the magnitude of the specular reflection can be quite significant compared to the desired diffuse reflection, especially in the darker printed areas, the areas tending to 100% solid ink coverage. Another example reflection densitometer uses three light sources at 45° to the page, equally spaced (120° apart) around the annulus. While not a true annular illuminator, an improvement in illumination uniformity over a point source is attained. Another example reflection densitometer uses a ring shaped mirror between a point source of light and the paper with suitable light baffles to block stray light. Light emerges from the point source, strikes the mirror, and is reflected through an annular region to the page.

### BRIEF DESCRIPTION OF THE DRAWINGS

Embodiments of the invention relating to both structure and method of operation may best be understood by referring to the following description and accompanying drawings:

FIGS. 1A and 1B are schematic pictorial diagrams showing embodiments of a printer apparatus that performs calibration for a reflection densitometer;

FIG. 2 is a schematic block diagram depicting an embodiment of a computer-implemented system in the form of an article of manufacture that performs calibration for a reflection densitometer in a printer apparatus;

FIG. 3 is a three-dimensional graphic view showing the optical geometry of the sensors depicted in FIGS. 1A, 1B, and 2;

FIGS. 4A and 4B are flow charts illustrating one or more embodiments or aspects of a method for method for calibrating a reflection densitometer in a printer;

FIGS. 5A and 5B show simplified computer code listing in the C language depicting an embodiment of a recursive search algorithm that can be used to determine calibration coefficients;

FIGS. 6A through 6G are data tables and graphs illustrating example calibrations of a reflection densitometer with respect to a laboratory reference densitometer;

FIG. 7 is a two-dimensional side view illustrating an optical diagram of an embodiment of sensing optics for a densitometer;

FIGS. 8A and 8B are respective three-dimensional and photographic perspective pictorial views (in different orientations) depicting an embodiment of optics for a sensor;

FIG. 9 is a graph showing International Standards Organization (ISO) standard optical geometry for reflection density;

FIGS. 10A and 10B are block and pictorial diagrams illustrating examples of prior-art sensors that conform to the ISO standard optical geometry; and

FIG. 11 is a perspective pictorial view illustrating conventional use of polarizing filters to attenuate gloss.

### DETAILED DESCRIPTION

Embodiments of printers, systems, and associated methods use three-point calibration for a reflection densitometer.

The depicted methods enable determination or calculation of the magnitude of the specular component of the detected light, and subtracting the effect of the specular component from density measurements made by an inexpensive reflection densitometer.

Consistent color reproduction from digital printers is attained by measurement and control of the density of each ink on a page. Reflection densitometers are used to measure the ink densities. In one embodiment, the reflection densitometer illuminates a patch on a page at 30° and detects the amount of diffusely reflected light at 0° wherein angles are with respect to the page surface normal. Ideally, the illumination is annular at 45°, providing illumination of a “flat” nature that deemphasizes gloss (specular reflections). Practically, a single light emitting diode (LED) can be used. With a single LED at 30°, the detected light has a significant gloss component, which is undesirable but unavoidable. A three-point calibration for a reflection densitometer is proposed which determines the magnitude of the gloss component and subtracts the determined magnitude from subsequent measurements. Measurements of patches of paper (0%), solid ink (100%), and a mid-tone level (about 90% ink coverage) are compared to the ideal values to determine the coefficients of the 3-point calibration. Then in operation the calibration coefficients are employed in an equation to calculate optical density as a function of the amount of reflected light that is measured.

According to an embodiment of a printer apparatus disclosed herein, a reflection densitometer can comprise an inexpensive optical sensor that has a single light emitting diode (LED) light source at 30°, lenses and light baffles, and a photodetector IC (integrated circuit) at 0°. The resulting reflection densitometer is much less expensive than either the three-light-source reflection densitometer or the reflection densitometer with the ring shaped mirror, and can be employed as an accurate reflection densitometer.

The depicted calibration technique enables substantial cost reduction in a printing system by enabling usage of lower-cost densitometers while maintaining excellent, consistent color quality.

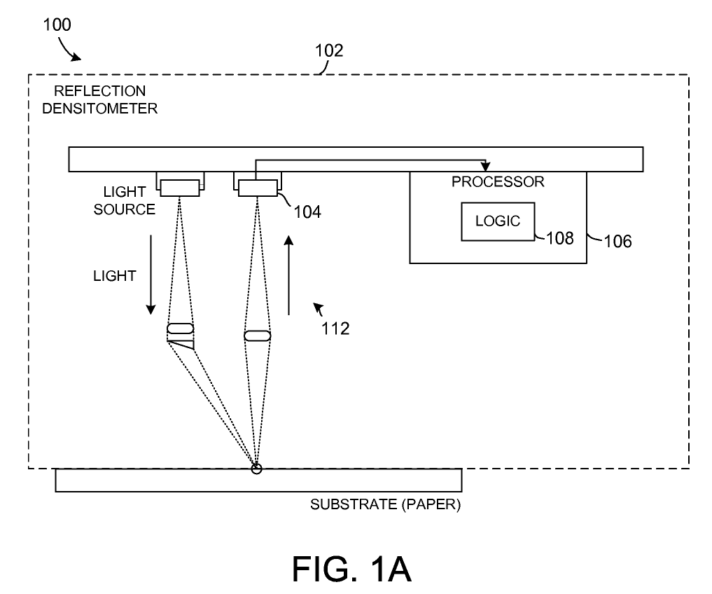

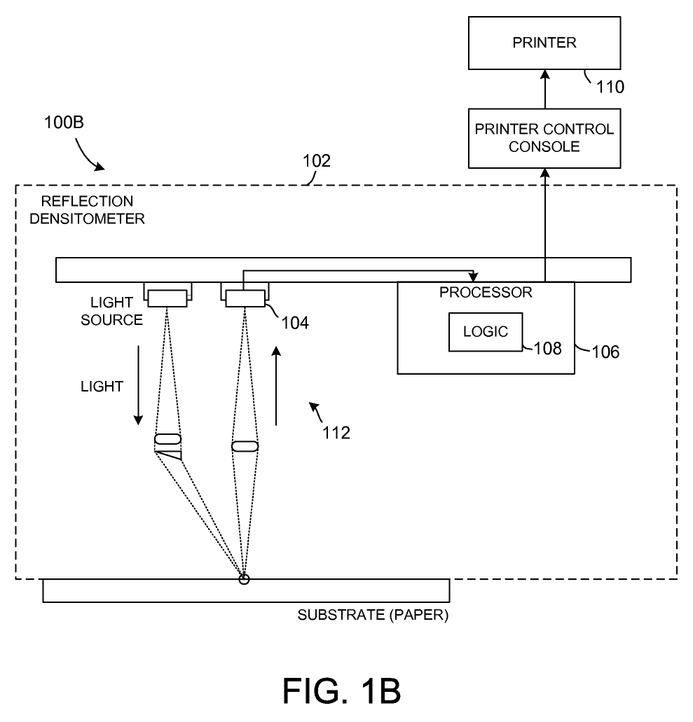

Referring to FIG. 1A, a schematic pictorial diagram illustrates an embodiment of a printer apparatus 100 that performs calibration for a reflection densitometer. The printer apparatus 100 includes a reflection densitometer 102 comprising an optical sensor 104 that detects light reflected from a patch on a page in a sequence of measurements, and a processor 106 which is coupled to the optical sensor 104 and manages the calibration operation. The processor 106 determines the magnitude of a gloss component of the illumination and compares the gloss component magnitude from a plurality of measurements at selected dissimilar ink coverage.

During calibration, the processor 106 determines the magnitude of the unwanted specular or gloss component of the reflected light by computation of the gloss component magnitude from a plurality of measurements at selected dissimilar ink coverage and comparison of the measurements to the correct optical density values determined by an external reference densitometer. During operation, the gloss component of the reflected light from a patch is subtracted before computing the measured optical density of the patch.

Accordingly, in an example implementation the processor 106 can perform a three-point calibration of the reflection densitometer constructed with the sensor 104 against a laboratory reference reflection densitometer. In the reflection densitometer 102, the sensor 104 illuminates three printed test patches and detects the intensity of light reflected from each patch. The first patch may be paper (0% ink coverage), the second patch may be a mid-tone (gray level) (about 80-90% ink coverage), and the third patch may be solid ink (100% ink coverage). The laboratory standard reflection densitometer can be used to measure the optical density of each patch. The processor 106 then performs the three-point calibration to determine three calibration coefficients that are used for calculations of reflection density as a function of detected light intensity. The densitometer measurements conform to the measurements made by a laboratory standard densitometer within ±0.01 OD (optical density).

In an example application or implementation, the processor 106 can perform a three-point calibration for the reflection densitometer 102 by determining the magnitude of the gloss component of the illumination and subtracting the magnitude from measurements at three ink coverage, for example including approximately 0% in coverage, a mid-tone coverage, and approximately 100% ink coverage.

In another example application or implementation, the processor 106 can perform a three-point calibration for the reflection densitometer 102 used with an optical sensor 104 and sensor optics 112 that reference to a laboratory reference reflection densitometer. The processor 106 can control the optical sensor 104 to illuminate three printed test patches, detect light intensity reflected from the patches, and calculate reflection density as a function of the detected light intensity using calibration coefficients determined using the laboratory standard densitometer.

The test patches of dissimilar ink coverage can be selected so that at least two of the test patches have strong diffuse reflection and measured optical density does not depend strongly on the gloss component, and at least one test patch has weak diffuse reflection and measured optical density strongly depends on the gloss component.

In an example three-patch application, the ink coverage for the three patches can be chosen so two of the patches (paper, mid-tone) have a strong diffuse reflection, and the third patch (100% solid) does not. Thus the measured optical density does not depend strongly on the gloss component for the first two patches, but certainly does for the third patch. The gloss component is expected to be about 1% of the reflection from paper, making the gloss component equal to the diffuse component for 100% solid deep blacks (optical density=2.0, or 1% diffuse reflection), that is subtracted.

In a typical embodiment, the printer apparatus 100 can be a color printer apparatus wherein the processor 106 calibrates for multiple ink colors using a separate set of stored calibration coefficients for the individual ink colors.

Thus the calibration procedure can be repeated for each ink color, and a separate set of calibration coefficients saved for each ink color. Usually the ink colors are the printing process colors (cyan, magenta, yellow, black), but also other ink colors that are used, for example, in Hewlett-Packard Indigo commercial digital presses (IndiChrome blue or orange, custom mixed colors) can be calibrated.

The definition of measured optical density (OD) as a function of reflected light intensity, converted to voltage (light-to-voltage or LTV), is:

OD=log₁₀(LTV for 100% reflective patch)−log₁₀(LTV for measured patch).

The LTV value for a perfect 100% reflective patch is not known a priori, so the specular (gloss) component of the detected light is subtracted, reformulating the equation as:

OD=b−a log₁₀(LTV for measured patch−c).

where a, b, and c are coefficients. Coefficient a is approximately 1, since the base of the logarithm is fixed and no non-linear terms are included in the LTV values. Coefficient b depends primarily on the LTV value for a perfect 100% reflective patch. Coefficient c depends primarily on the strength of the gloss (specular) reflection. Coefficient c is inserted into the equation to account for the LTV component contributed by the specular (gloss) reflection, which is subtracted. Coefficients a, b, and c remain to be determined.

For the three patches {P₁, P₂, P₃} densities measured by the laboratory reference densitometer can be denoted as {OD₁, OD₂, OD₃} and measured LTV values denoted as {LTV₁, LTV₂, LTV₃}. Thus, a system of three non-linear equations for coefficients a, b, and c can be solved, either analytically or numerically.

Accordingly, the printer apparatus 100 can further comprise logic 108 that computes at least one set of calibration coefficients wherein measured optical density (OD) is defined as a function of reflected light intensity converted to voltage (light-to-voltage LTV). The logic 108 can determine coefficients a, b, c by simultaneously solving equations:

OD₁=b−a log₁₀(LTV₁−c)

OD₂=b−a log₁₀(LTV₂−c)

OD₃=b−a log₁₀(LTV₃−c)

where (OD₁, OD₂, OD₃) are density measured by a laboratory reference densitometer and (LTV₁, LTV₂, LTV₃) are measured LTV values corresponding to test patches (P₁, P₂, P₃).

In practice, an algorithm that guesses a value for coefficient c can be implemented. The remaining equations can then form a system of linear equations that are easily solved for the values of coefficients a and b. Denoting the densities calculated by the densitometer as {OD₄, OD₅, OD₆} as a function of coefficients a, b, and c and the measured LTV values as {LTV₁, LTV₂, LTV₃}, the measured ODs can be found as:

OD₄=b−a log₁₀(LTV₁−c)

OD₅=b−a log₁₀(LTV₂−c)

OD₆=b−a log₁₀(LTV₃−c).

The error between measurements on the reflection densitometer 102 and measurements made by the laboratory standard densitometer can be calculated according to an equation as follows:

Error=|OD₄−OD₁|+|OD₅−OD₂|+|OD₆−OD₃|.

The value of coefficient c lies between zero (the gloss component is zero) and LTV₃ (the entire reading for patch P₃ is gloss, the diffuse component is zero), defining the search range.

A recursive search for coefficient c can be implemented, for example by subdividing the search range into ten parts, then beginning calculation (as a function of coefficient c) of coefficients a and b, the measured densities {OD₄, OD₅, OD₆}, and the error. The search can be made from the low end of the search range towards the high end. For increasing values of coefficient c, the error decreases towards a minimum, passes through the minimum, and then begins increasing, whereupon the current search terminates. Then a new search is initiated, bounded by the values of coefficient c found around the minimum. After 7 or 8 recursions, the value of coefficient c converges to standard IEEE floating point precision, and the algorithm terminates.

The depicted algorithm is one example of a root finding algorithm of which many examples exist in the mathematics literature. Another method can reformulate the error as:

Error=(OD₄−OD₁)²+(OD₅−OD₂)²+(OD₆−OD₃)²

then sets the derivative d(Error)/dc=0 to find the minimum and the desired value of coefficient c. The absolute value |x| can be switched to squared values x² to enable the derivative to be calculated analytically. The resulting value of coefficient c can be called the “minimum mean squared error” in the mathematics literature.

A numerical example can be used to illustrate results of the recursive algorithm:

{OD₁,OD₂,OD₃}={0.063,0.948,1.647}

{LTV₁,LTV₂,LTV₃}={2.440619,0.361546,0.109575}.

The algorithm terminates with coefficients a, b, and c as follows:

a=1.005662

b=0.444407

c=0.045869.

Accordingly measured ODs can be calculated:

{OD₄,OD₅,OD₆}={0.063,0.948,1.647}

which agrees with measurements from the laboratory reference densitometer.

Referring to FIG. 1B, an embodiment of a printer apparatus 100B can comprise a printer 110 that includes the reflection densitometer 102.

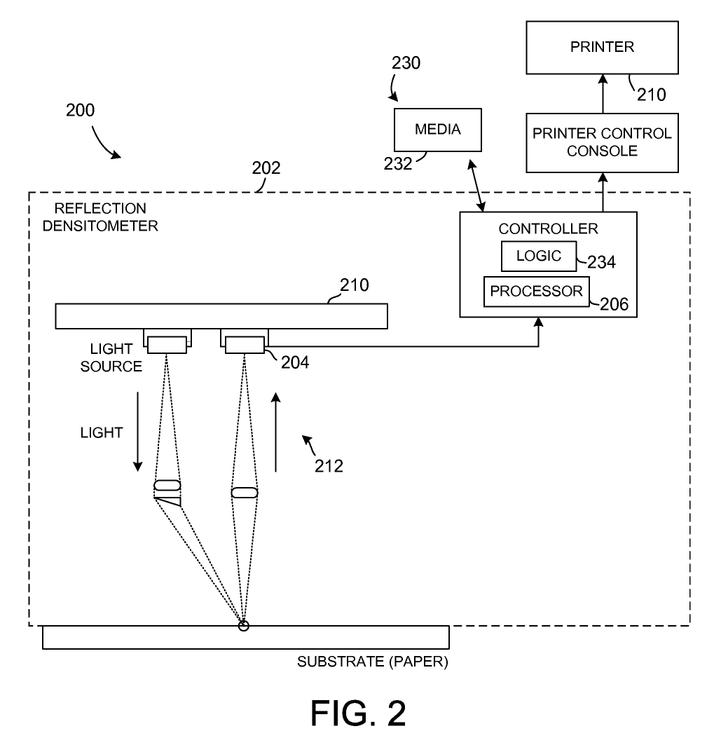

Referring to FIG. 2, a schematic block diagram illustrates an embodiment of a computer-implemented system 200 in the form of an article of manufacture 230 that performs calibration for a reflection densitometer 202 for usage with a printer 210. The article of manufacture 230 comprises a processor-usable medium 232 having a computer readable program code 234 embodied in the processor 206 for calibrating the reflection densitometer 202. The computer readable program code 234 comprises code causing the processor 206 to perform a three-point calibration for the reflection densitometer 202 used with an optical sensor 204 that references to a laboratory reference reflection densitometer. The computer readable program code 234 further comprises code causing the processor 206 to control the optical sensor 204 to illuminate three printed test patches, code causing the processor 206 to detect light intensity reflected from the patches via sensor optics 212, and code causing the processor 206 to calculate reflection density as a function of the detected light intensity using calibration coefficients determined using the laboratory standard densitometer.

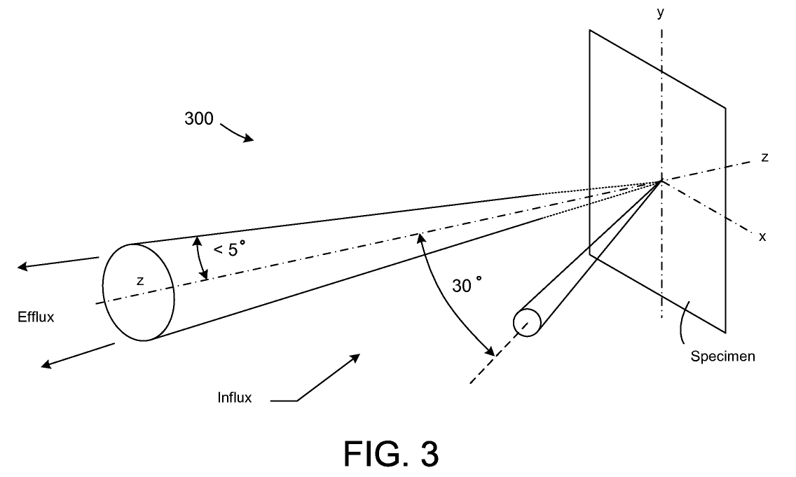

Referring to FIG. 3, a three-dimensional graphic view shows the optical geometry 300 of the sensor 100, 200 depicted in FIGS. 1A, 1B, and 2. For each chromatic, the sensor 100, 200 substitutes a single LED (light emitting diode) at 30° for the annular illumination in the ISO standard. In an illustrative embodiment, the sensor 100, 200 can have three LEDs corresponding to red, green, and blue chromatics. Only one LED is activated at a time to selected one RGB (red-green-blue) measurement wavelength so that only one chromatic (CMYK) ink density measurement is made at a time. This is conventional practice in reflection densitometry. Additional measurements with a different LED activated may be made to obtain reflection density measurements for all three RGB primaries. The green LED is conventionally activated to make measurements of black ink (K) as the green wavelength most closely matches the human visual response for brightness.

The optical geometry 300 produces very directional lighting, which tends to emphasize surface texture. The directional lighting does not illuminate at 45° but rather at 30°, which unfortunately emphasizes gloss. Thus the optical geometry is not ideal but enables a highly inexpensive sensor which is operated to achieve acceptable measurement accuracy.

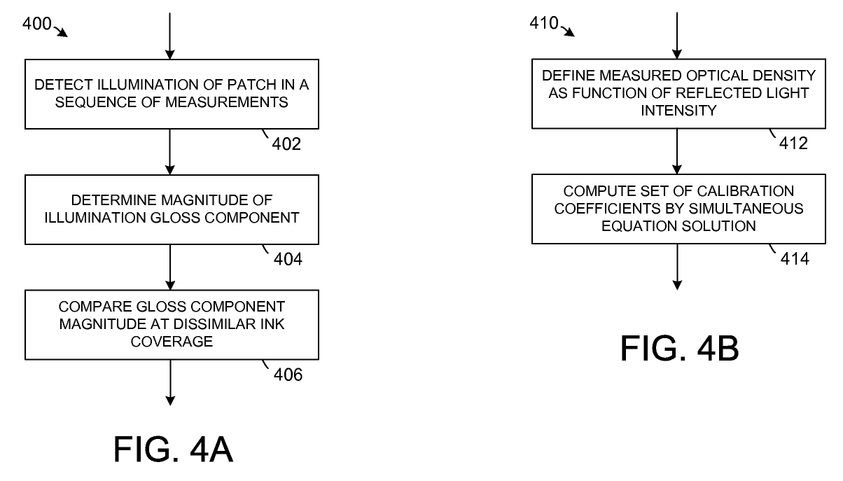

Referring to FIGS. 4A and 4B, flow charts illustrate one or more embodiments or aspects of a method for method for calibrating a reflection densitometer in a printer. FIG. 4A depicts a method 400 for calibrating a printer apparatus comprising actions of detecting 402 reflected light from a patch on a page in a sequence of measurements, determining 404 the magnitude of a gloss component of the reflected light, and comparing 406 the gloss component magnitude from a plurality of measurements at selected dissimilar ink coverage.

Referring to FIG. 4B, a method 410 for calibrating a printer apparatus comprising actions of defining 412 measured optical density (OD) as a function of reflected light intensity converted to voltage (light-to-voltage LTV), and computing 414 at least one set of calibration coefficients a, b, c by simultaneously solving equations:

OD₁=b−a log₁₀(LTV₁−c)

OD₂=b−a log₁₀(LTV₂−c)

OD₃=b−a log₁₀(LTV₃−c)

where (OD₁, OD₂, OD₃) are density measured by a laboratory reference densitometer and (LTV₁, LTV₂, LTV₃) are measured LTV values corresponding to test patches (P₁, P₂, P₃).

The magnitude of the unwanted specular or gloss component of the reflected light from a patch is determined by computing the gloss component magnitude from a plurality of measurements at selected dissimilar ink coverage (different patches) and comparison of the measurements to the correct optical density values determined by an external reference densitometer. Then in operation, the gloss component of the reflected light from a patch is subtracted before computing the measured optical density of the patch. Subtracting the unwanted gloss component leaves only the desired diffuse component.

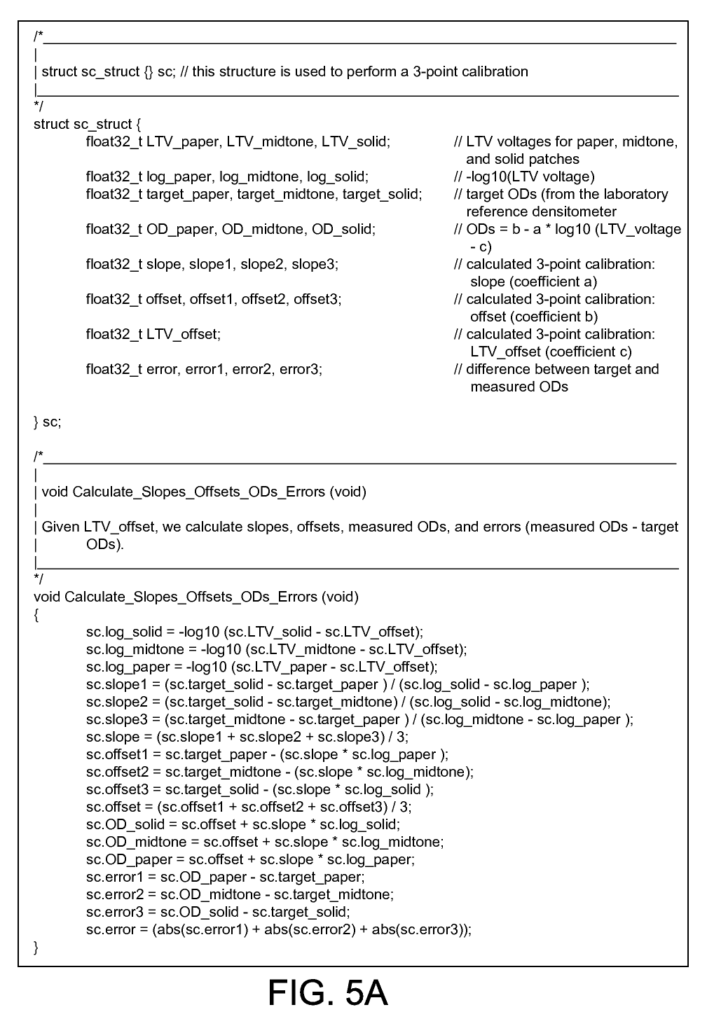

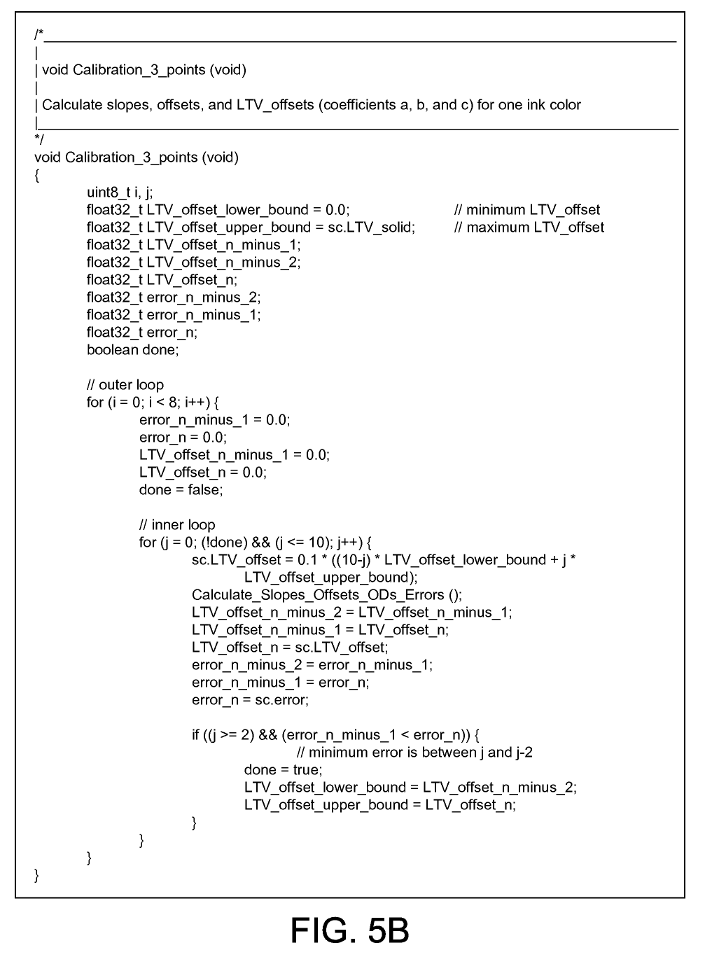

Referring to FIGS. 5A and 5B, a simplified computer code listing in the C language depicts an embodiment of a recursive search algorithm that can be used to determine calibration coefficients.

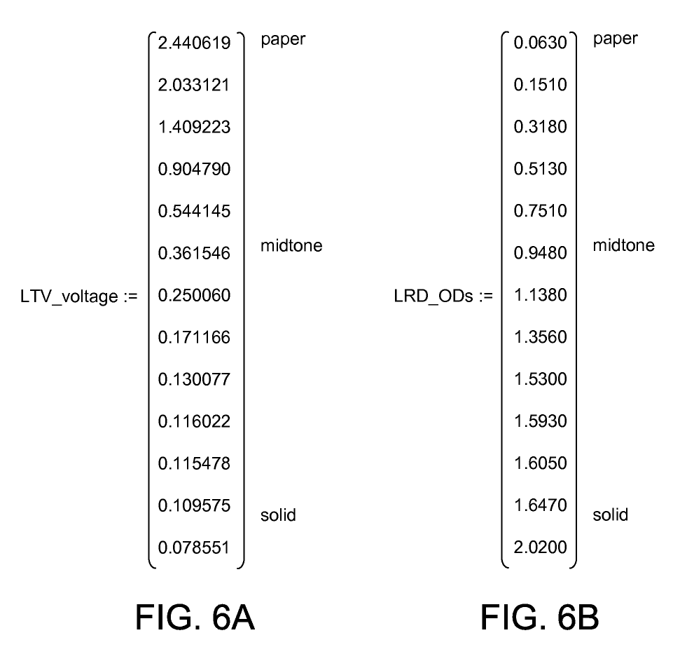

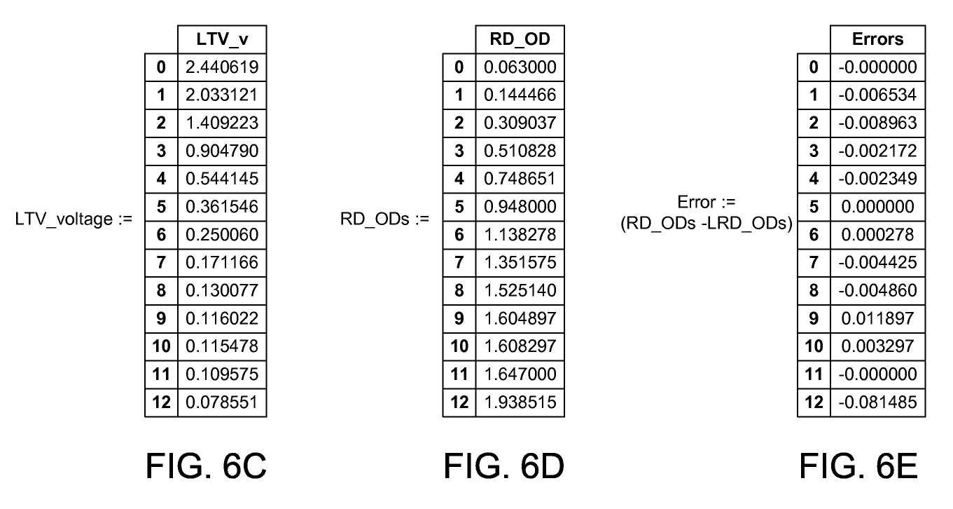

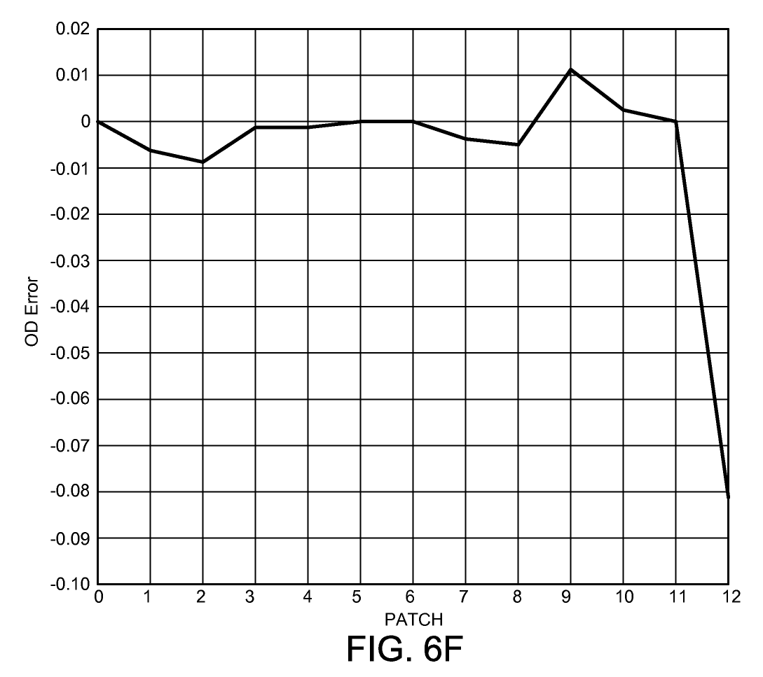

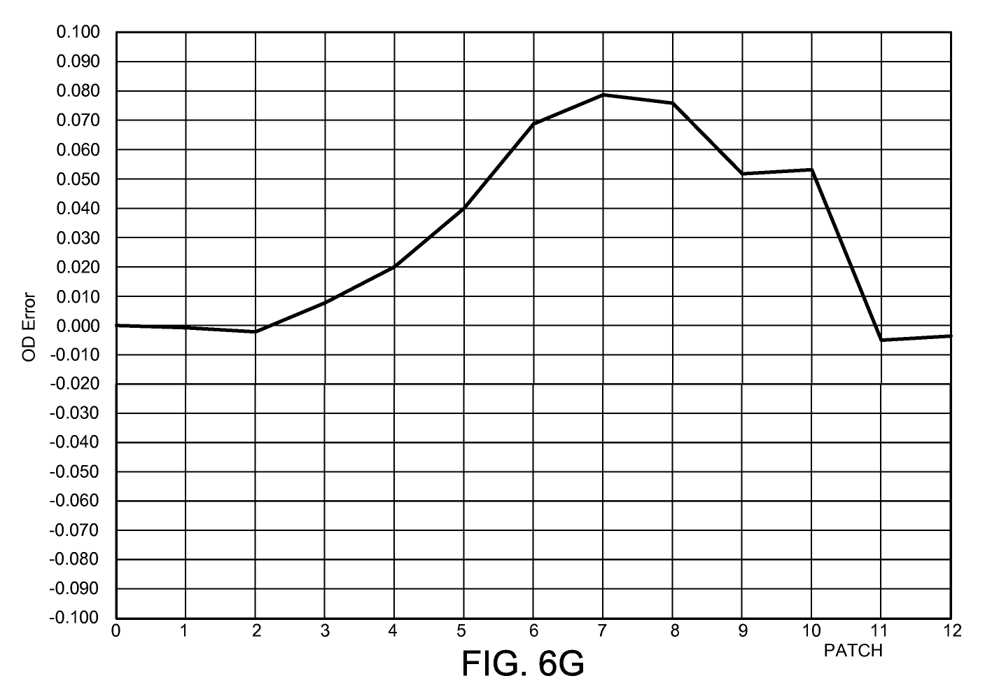

Referring to FIGS. 6A through 6G, several data tables and graphs illustrate an example calibration of a reflection densitometer with respect to a laboratory reference densitometer. In the example, a reflection densitometer can be calibrated by printing test patches of each of multiple colors including 0% coverage (paper), 100% coverage (solid), and a test patch at about 90% coverage (mid-tone).

The optical densities (ODs) of the patches are measured with a bench-top, laboratory reference densitometer. After calibration, measurements of the reflection densitometer should agree with the laboratory reference densitometer.

The purpose of calibration is to determine calibration coefficients a, b, and c for each color that relate the log (base 10) of the LTV voltage (output of the light-to-voltage sensor integrated circuit inside the reflection densitometer) for each patch to the optical density measured by the laboratory reference densitometer.

The definition of optical density (OD) is:

OD(reflectance):=−log(reflectance)(log base 10)

so, for example, if reflectance=0.095 then computed OD(reflectance) is equal to 1.022276.

Reflectance varies from 1.0 for a perfect 100% white reflector to about 0.03 to 0.01 for a sample with black OD from 1.5 to 2.0.

Firmware in the reflection densitometer (RD) can use the following equation to calculate OD (RD_OD) from LTV voltage:

RD_OD(a,b,c,LTV_voltage)=b−a·log(LTV_voltage−c).

FIG. 6A is a data table showing sample LTV voltages measured from a strip of patches of a gray ramp (0%, 10%, 20%, . . . , 80%, 90%, 100%, 200% coverage). The three marked patches are selected for the three-point calibration. The 200% coverage point corresponds to a double impression of the ink color, and may appear as an outlier in the measurement results. On optical inspection, the gloss of patches with this coverage differs from the rest. In practice, a printing press would not be measuring the optical density of anything but single impressions (0 to 100% coverage). FIG. 6B is a data table that depicts results for the selected calibration patches.

Coefficients a and b can be calculated as the slope and intercept of a line relating the ODs of the laboratory reference densitometer (LRD_OD) and the logarithms of the LTV voltages. Ideally, coefficient a is equal to one since other values imply an unusual power-law fit. Equation y=a·log(x) is equivalent to y=log(x^{a}). Physically, coefficient b is the logarithm of (LTV_voltage−c) for a perfect reflector (OD=0.0). Therefore:

$$Coefficient\_a := \frac{{LRD}_{{OD}_{s}} - {LRD}_{{DO}_{s}}}{log ( {LTV}_{s} - c ) - log ( {LTV}_{2} - c )} ;$$

$$Coefficient\_b := {LRD}_{OD} + a \cdot log ( LTV - c ) .$$

Coefficient c is related to the unwanted detection of gloss (specular reflection). In a perfect world, only light from the diffuse reflection would be detected.

Coefficient c is difficult to attain by a closed form solution and can be found more easily by iteration. The value of coefficient c lies between c=0 (no specular light detected) and c=LTV_solid (light detected from solid patch is all specular).

Manipulating the value of coefficient c, the error goes to zero at c=0.0458694 as shown in a sequence of equations as follows:

$$LTV\_solid = 0.109575 ;$$

$$c := 0.0458694 ;$$

$$\begin{matrix}a 1 := Coefficient\_a ( \begin{matrix}c , LTV\_paper , LTV\_solid , \\ LRD\_OD \_paper , LRD\_OD \_solid\end{matrix} ) ; \\ = 1.005662 ;\end{matrix}$$

$$\begin{matrix}a 2 := Coefficient\_a ( \begin{matrix}c , LTV\_paper , LTV\_midtone , \\ LRD\_OD \_paper , LRD\_OD \_midtone\end{matrix} ) ; \\ = 1.005662 ;\end{matrix}$$

$$\begin{matrix}a 3 := Coefficient\_a ( \begin{matrix}c , LTV\_midtoner , LTV\_solid , \\ LRD\_OD \_midtone , LRD\_OD \_solid\end{matrix} ) ; \\ = 1.005662 ;\end{matrix}$$

$$\begin{matrix}a := ( a 1 + a 2 + a 3 ) / 3 \\ = 1.005662 \end{matrix} ;$$

$$\begin{matrix}b 1 := Coefficient\_a ( a , c , LTV\_solid , LRD\_OD \_solid ) \\ = 0.444407\end{matrix} ;$$

$$\begin{matrix}b 2 := Coefficient\_a ( a , c , LTV\_midtone , LRD\_OD \_midtone ) \\ = 0.444407\end{matrix} ;$$

$$\begin{matrix}b 3 := Coefficient\_a ( a , c , LTV\_paper , LRD\_OD \_paper ) \\ = 0.444407\end{matrix} ;$$

$$\begin{matrix}b := ( b 1 + b 2 + b 3 ) / 3 \\ = 0.444407 \end{matrix} ;$$

$$\begin{matrix}OD\_paper := RD\_OD ( a , b , c , LTV\_paper ) \\ = 0.063000\end{matrix} ;$$

$$\begin{matrix}OD\_midtone := RD\_OD ( a , b , c , LTV\_midtone ) \\ = 0.948000\end{matrix} ;$$

$$\begin{matrix}OD\_solid := RD\_OD ( a , b , c , LTV\_solid ) \\ = 1.647000\end{matrix} ;$$

$$\begin{matrix}error 1 := \vert OD\_paper - LRD\_OD \_paper \vert \\ = 0.000000\end{matrix} ;$$

$$\begin{matrix}error 2 := \vert OD\_midtone - LRD\_OD \_midtone \vert \\ = 0.000000\end{matrix} ;$$

$$\begin{matrix}error 3 := \vert OD\_solid - LRD\_OD \_solid \vert \\ = 0.000000\end{matrix} ;$$

$$error = 0.000000 .$$

Referring to FIGS. 6C, 6D, and 6E, data tables respectively illustrate measurements of LTV_voltage, RD_OD, and OD_error defined as the difference between RD_OD and LRD_OD, each for twelve test patches. FIGS. 6F and 6G are graphs showing OD_error for the test patches for two example tests.

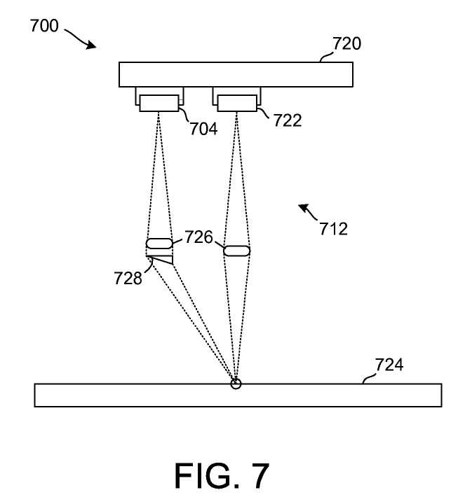

Referring to FIG. 7, a two-dimensional cross-sectional view is an optical diagram showing an embodiment of sensing optics 712 for a densitometer 700. The sensing optics 712 can be arranged for at least partial mounting on a printed circuit (PC) board 720. For example, a light emitting diode (LED) 704 which is operative as a light source and a photodetector 722 integrated circuit can be mounted on the PC board 720. The LED 704 directs light to a substrate 724 (for example paper) through a lens 726 and prism 728. The light is reflected from the substrate 724 back through a lens 726 to the photodetector 722.

The sensor for the densitometer 700 can be configured, for example, to make three separate measurements for cyan, magenta, and yellow (CMY) ink densities at red, green, and blue (RGB) wavelengths. The green wavelength can be used for measurements of black (K) ink density.

The optics 712 includes light collecting and focusing optics. In an example embodiment, the entire sensor can fit within a cubic inch. The lenses 726 can be simple, small, commercially-available lenses.

The optical geometry formed by the sensing optics 712 enables a highly effective performance in an inexpensive arrangement at the cost of non-conformance to the ISO standard 5-4:1995.

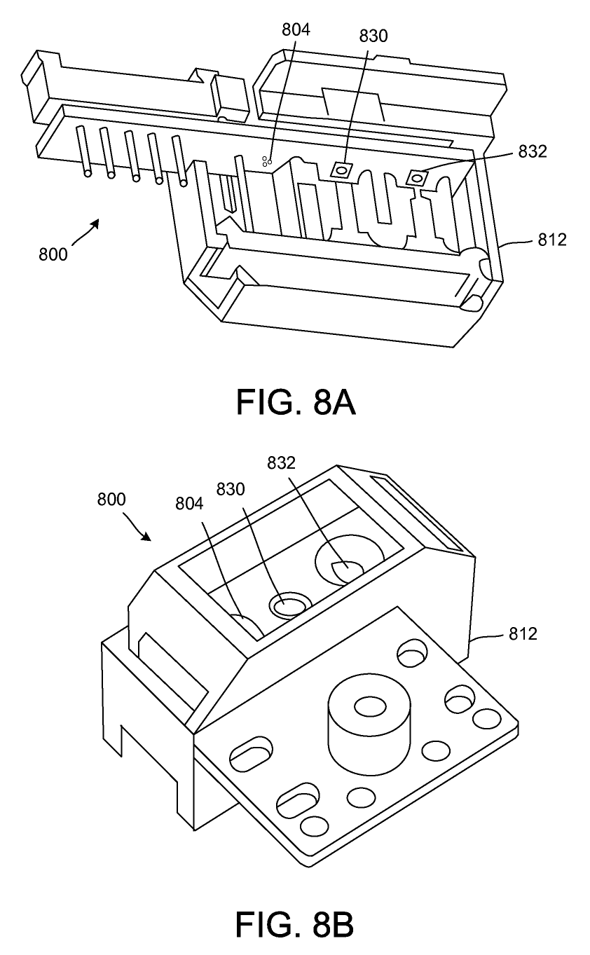

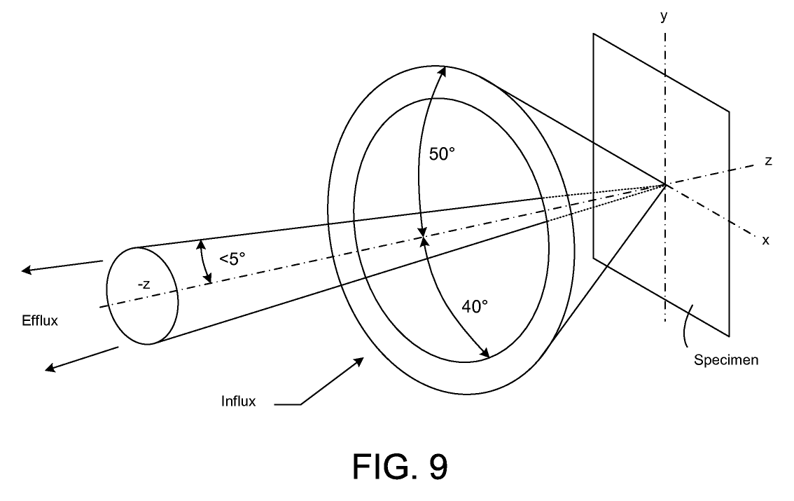

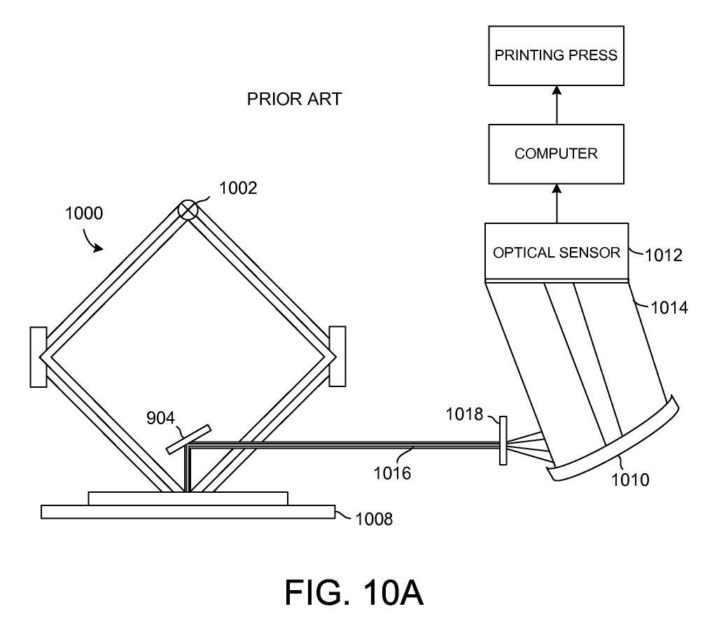

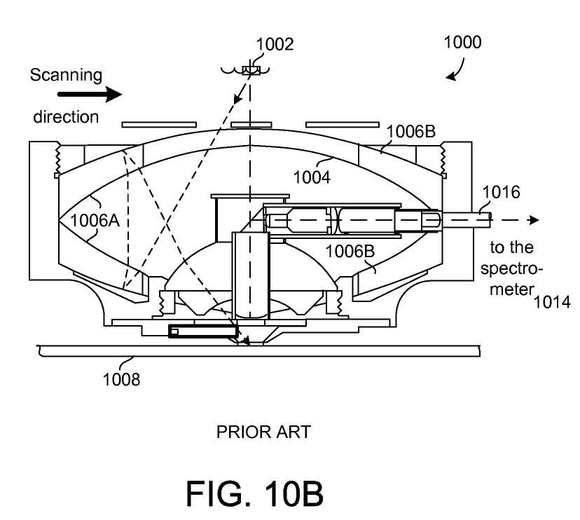

The lenses 726 and prism 728 can be fabricated in a single molded plastic piece. For example, FIGS. 8A and 8B are respectively three-dimensional and photographic perspective pictorial views (in different orientations) depicting an embodiment of optics 812 for a sensor 800. The illustrative optics 812 enables implementation of an inexpensive optical sensor 800.

The illustrative sensor 800 includes three LEDs 804 and sensor elements including a diffuse sensor 830 and a specular sensor 832.

The three LEDs 804 can be mounted to the PC board in bare die form, in mutual close proximity. In example operation, only one LED can be activated at a time for measurement at a single red, green, or blue wavelength. The sensor 802 can include or omit the specular sensor photodetector 832 for specular or glossy reflections.

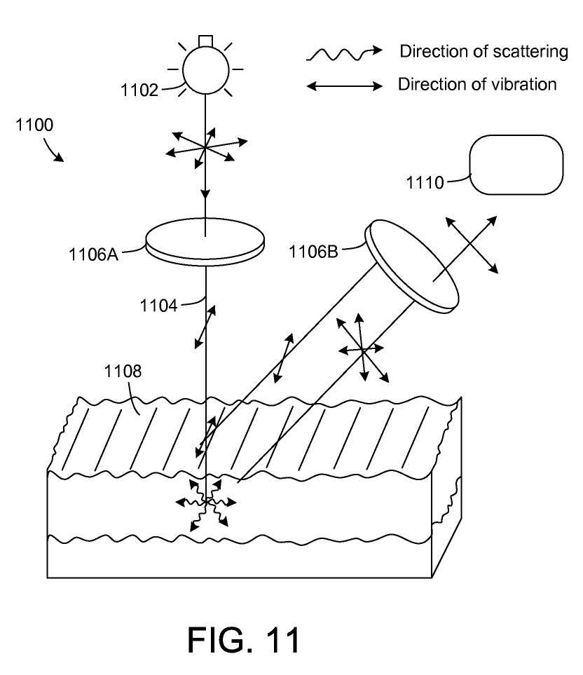

FIG. 11 is a perspective pictorial view illustrating conventional use of polarizing filters to attenuate gloss. The example configuration of optical polarizing filters can attenuate specular or glossy reflections on smooth surface structures during measurement of optical density. A densitometer can measure wet ink and dry ink with wet ink characterized by a relatively smooth and glossy surface. The ink adapts to the structure of the paper surface during drying and loses some gloss as the drying ink forms an irregular, rough structure. Thus, optical density measurements differ based on dryness or wetness of the ink with the measured density value for wet ink higher than for dry ink.

In a conventional arrangement 1100 that compensates for this variability in optical density measurements, two crossed linear polarizing filters 1106A, 11068 can be placed in the beam path 1104. Light waves are emitted from a light source 1102 in all directions and polarizing filters 1106A, 11068 are used to allow only waves moving in a selected direction to pass. Some light waves polarized by a first polarization filter 1106A are reflected by the ink surface in a specular manner in which direction is not altered. A second polarizing filter 11068 can be aligned at an angle of 90° to the first filter 1106A so that reflected light waves cannot pass, thereby suppressing specularly reflected light for the measurement. Light beams that penetrate the ink film and are reflected either by the ink or by the substrate 1108 (paper) lose uniform polarization and thus are, in part, allowed to pass by the second polarizing filter 11068 to reach a receiver 1110. The technique operates by blocking portions of light specularly reflected by the wet ink to obtain approximately identical readings from wet and dry inks. Thus, wet ink with more gloss is measured as if already dry. Absorption by the polarizing filter causes less reflected light to reach the receiver, resulting in slightly higher measured values.

In contrast to the traditional technique, the illustrative sensors 100, 200, 700 shown in FIGS. 1A, 1B, 2, and 7 do not incorporate polarizing filters due to the inefficiency of such filters (25% to 50% transmission) which would result in light losses (75% to 88% for a system with two polarizing filters). Light losses of this order would be intolerable in a system that uses light-emitting diodes (LEDs) as a light source. Accordingly, the sensors disclosed herein enable a low-cost system with good performance without usage of polarizing filters. The polarizing filters can be omitted in the disclosed sensors because of the light losses that would result.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks in a manufacturing process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A printer apparatus 100 comprising:
a reflection densitometer 102 comprising:
an optical sensor 104 that detects light reflected from a patch on a page in a sequence of measurements; and
a processor 106 coupled to the optical sensor 104 that determines magnitude of a gloss component of the reflected light and compares the gloss component magnitude from a plurality of measurements at selected dissimilar ink coverage.

2. The apparatus 100 according to claim 1 further comprising:
the processor 106 that performs a three-point calibration for the reflection densitometer 102 and determines the magnitude of the gloss component of the reflected light and subtracts the magnitude from measurements at three ink coverage comprising approximately 0% in coverage, mid-tone, and approximately 100% ink coverage.

3. The apparatus 100 according to claim 1 further comprising:
the processor 106 that performs a three-point calibration for the reflection densitometer 102 used with the optical sensor 104 that references to a laboratory reference reflection densitometer, the processor 106 controlling the optical sensor 104 to illuminate three printed test patches, detect light intensity reflected from the patches, and calculate reflection density as a function of the detected light intensity using calibration coefficients determined using the laboratory standard densitometer.

4. The apparatus 100 according to claim 1 wherein:
the dissimilar ink coverage are selected wherein at least two test patches have strong diffuse reflection and measured optical density does not depend strongly on the gloss component, and at least one test patch has weak diffuse reflection and measured optical density strongly depends on the gloss component.

5. The apparatus 100 according to claim 1 further comprising:
a printer 110 comprising the reflection densitometer 102, the printer 110 operative as a color printer apparatus 100 comprising the processor 106 that calibrates for a plurality of ink colors using a separate set of stored calibration coefficients for individual ink colors.

6. The apparatus 100 according to claim 1 further comprising:
logic 108 that computes at least one set of calibration coefficients wherein measured optical density (OD) is defined as a function of reflected light intensity converted to voltage (light-to-voltage LTV), the logic 108 determining coefficients a, b, c by simultaneously solving equations:
OD₁=b−a log₁₀(LTV₁−c)
OD₂=b−a log₁₀(LTV₂−c)
OD₃=b−a log₁₀(LTV₃−c)
where (OD₁, OD₂, OD₃) are density measured by a laboratory reference densitometer and (LTV₁, LTV₂, LTV₃) are measured LTV values corresponding to test patches (P₁, P₂, P₃).

7. The apparatus 100 according to claim 1 further comprising:
the processor 106 operative during calibration to determine magnitude of unwanted specular or gloss components of reflected light by computing a gloss component magnitude from a plurality of measurements at selected dissimilar ink coverage and comparing the plurality of measurements to correct optical density values determined by an external reference densitometer; and
the processor 106 operative after calibration to subtract the gloss component magnitude from a patch before computing measured optical density of the patch.

8. The apparatus 100 according to claim 1 further comprising:
an article of manufacture comprising:
a processor-usable medium having a computer readable program code embodied in the processor 106 for calibrating the reflection densitometer 102, the computer readable program code further comprising:
code causing the processor 106 to perform the three-point calibration for the reflection densitometer 102 used with the optical sensor 104 that references to a laboratory reference reflection densitometer;
code causing the processor 106 to control the optical sensor 104 to illuminate three printed test patches;
code causing the processor 106 to detect light intensity reflected from the patches; and
code causing the processor 106 to calculate reflection density as a function of the detected light intensity using calibration coefficients determined using the laboratory standard densitometer.

9. A printer apparatus 100 comprising:
logic 108 that computes at least one set of calibration coefficients wherein measured optical density (OD) is defined as a function of reflected light intensity converted to voltage (light-to-voltage LTV) for usage by a reflection densitometer 102 that detects light reflected from a patch on a page in a sequence of measurements, determines magnitude of a gloss component of the reflected light, and computes the gloss component magnitude from a plurality of measurements at selected dissimilar ink coverage levels.

10. The apparatus 100 according to claim 9 further comprising:
the logic 108 computing at least one set of calibration coefficients for performing a three-point calibration for the reflection densitometer 102 and determines the magnitude of the gloss component of the reflected light and subtracts the magnitude from measurements at three ink coverage levels comprising approximately 0% in coverage, mid-tone, and approximately 100% ink coverage.

11. The apparatus 100 according to claim 9 wherein:
the dissimilar ink coverage levels are selected wherein at least two test patches have strong diffuse reflection and measured optical density does not depend strongly on the gloss component, and at least one test patch has weak diffuse reflection and measured optical density strongly depends on the gloss component.

12. The apparatus 100 according to claim 9 further comprising:
the logic 108 computing a plurality of sets of calibration coefficients for a plurality of ink colors in a color printer apparatus, and storing the calibration coefficients for individual ink colors, wherein:
the logic 108 determines coefficients a, b, c by simultaneously solving equations:
OD₁=b−a log₁₀(LTV₁−c)
OD₂=b−a log₁₀(LTV₂−c)
OD₃=b−a log₁₀(LTV₃−c)
where (OD₁, OD₂, OD₃) are density measured by a laboratory reference densitometer and (LTV₁, LTV₂, LTV₃) are measured LTV values corresponding to test patches (P₁, P₂, P₃).

13. A method 400 for calibrating a printer apparatus comprising:
detecting 402 reflected light from a patch on a page in a sequence of measurements;
determining 404 magnitude of a gloss component of the reflected light; and
computing 406 the gloss component magnitude from a plurality of measurements at selected dissimilar ink coverage.

14. The method 410 according to claim 13 further comprising:
defining 412 measured optical density (OD) as a function of reflected light intensity converted to voltage (light-to-voltage LTV);
computing 414 at least one set of calibration coefficients a, b, c by simultaneously solving equations:
OD₁=b−a log₁₀(LTV₁−c)
OD₂=b−a log₁₀(LTV₂−c)
OD₃=b−a log₁₀(LTV₃−c)
where (OD₁, OD₂, OD₃) are density measured by a laboratory reference densitometer and (LTV₁, LTV₂, LTV₃) are measured LTV values corresponding to test patches (P₁, P₂, P₃).

15. The method according to claim 13 further comprising:
determining magnitude of unwanted specular or gloss components of reflected light during calibration comprising:
computing a gloss component magnitude from a plurality of measurements at selected dissimilar ink coverage; and
comparing the plurality of measurements to correct optical density values determined by an external reference densitometer; and
operating after calibration comprising:
subtracting the gloss component magnitude from a patch; and
computing measured optical density of the patch after the gloss component magnitude is subtracted.
